(19) United States
(12) Patent Application Publication
(10) Pub. No.: US 2016/0125314 A1
(43) Pub. Date: May 5, 2016

(54) SYSTEMS AND METHODS FOR NATIVE ADVERTISEMENT SELECTION AND FORMATTING

(71) Applicant: Yahoo! Inc., Sunnyvale, CA (US)

(72) Inventors: Ramkartik Mulukutla, Santa Clara, CA (US); Tejal Parulekar, Sunnyvale, CA (US); Sreenivasulu Jaladanki, San Ramon, CA (US)

(73) Assignee: Yahoo! Inc., Sunnyvale, CA (US)

(21) Appl. No.: 14/528,422

(22) Filed: Oct. 30, 2014

(51) Int. Cl. G06N 99/00; G06Q 30/02

(52) U.S. Cl. CPC G06N 99/005; G06Q 30/0277

(57) ABSTRACT

Provided herein is a system or method for a native advertisement selection and formatting module operable to monitor displayable content and store characteristic-related information relating to the monitored content, including keyword-related information and format-related information, utilize one or more machine learning-based algorithms, analyze the characteristic-related information relating to the monitored content, including the keyword-related information and the format-related information, and based in part on the analysis, output detailed contextual settings, and select and format native advertisements to be displayed in visual association with the displayable content, based in part on the detailed contextual settings.

### BACKGROUND

Native advertising, as well as native content generally, is of increasing importance. Native advertising appears seamlessly and naturally, creates a more enjoyable experience for users, increases engagement, and improves performance for advertisers. For example, native advertisements may perform well, yet may be relatively unobtrusive to the user's experience and help advertisers reach consumers in a contextually relevant, effective way.

### SUMMARY

An aspect of some embodiments of the invention provides a system comprising one or more processors and a non-transitory storage medium comprising program logic for execution by the one or more processors, the program logic comprising a native advertisement selection and formatting module operable to monitor displayable content and store characteristic-related information relating to the monitored content, including keyword-related information and format-related information, utilize one or more machine learning-based algorithms, analyze the characteristic-related information relating to the monitored content, including the keyword-related information and the format-related information, based in part on the analysis, output detailed contextual settings, and select and format native advertisements to be displayed in visual association with the displayable content, based in part on the detailed contextual settings.

An aspect of some embodiments of the invention provides a method comprising monitoring displayable content and storing characteristic-related information relating to the monitored content, including keyword-related information and format-related information, utilizing one or more machine learning-based algorithms, analyzing the characteristic-related information relating to the monitored content, including the keyword-related information and the format-related information, outputting detailed contextual settings based in part on the analysis, and selecting and formatting native advertisements to be displayed in visual association with the displayable content, based in part on the detailed contextual settings.

An aspect of some embodiments of the invention provides a non-transitory computer-readable storage medium or media tangibly storing computer program logic capable of being executed by a computer processor, the program logic comprising a native advertisement selection and formatting engine logic operable to monitor displayable content and store characteristic-related information relating to the monitored content, including keyword-related information and format-related information, utilize one or more machine learning-based algorithms, analyze the characteristic-related information relating to the monitored content, including the keyword-related information and the format-related information, and based in part on the analysis, output detailed contextual settings, and select and format native advertisements to be displayed in visual association with the displayable content, based in part on the detailed contextual settings.

### BRIEF DESCRIPTION OF THE DRAWINGS

FIG. 1 illustrates a block diagram of a distributed computer system that can implement one or more aspects of a Native Advertisement Selection and Formatting system or method according to an embodiment of the invention;

FIG. 2 illustrates a block diagram of an electronic device that can implement one or more aspects of a Native Advertisement Selection and Formatting system or method according to an embodiment of the invention;

FIG. 3 illustrates a block diagram of a graphical user interface according to one or more aspects of a Native Advertisement Selection and Formatting system or method according to an embodiment of the invention;

FIGS. 4-6 illustrate flow diagrams of example operations of one or more aspects of a Native Advertisement Selection and Formatting system or method according to an embodiment of the invention;

FIGS. 7-10 illustrate diagrams of example operations of one or more aspects of a Native Advertisement Selection and Formatting system or method according to an embodiment of the invention; and

FIG. 11 illustrates a block diagram of graphical user interfaces according to one or more aspects of a Native Advertisement Selection and Formatting system or method according to an embodiment of the invention.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.” Herein, “ad” and “advertisement” are used interchangeably.

It is noted that description herein is not intended as an extensive overview, and as such, concepts may be simplified in the interests of clarity and brevity.

Herein, native ads, native ad placement, and placement, among other terms, are intended to have broad scope. Native ads can be or include, without limitation, any of many different types of advertisements, including all that are described herein, among others. “Placement”, as the term is used herein, is intended to have broad scope, covering, and can include, among other things, activities or conduct in connection with obtaining, storing, determining, configuring, selecting, ranking, retrieving, targeting, matching, serving and presenting items, such as advertisements. Furthermore, although embodiments are described largely in connection with Native Advertisement Selection and Formatting, various embodiments and techniques can be used in other areas, such as, for instance, non-advertising item or content placement, or other areas including non-advertising items or content.

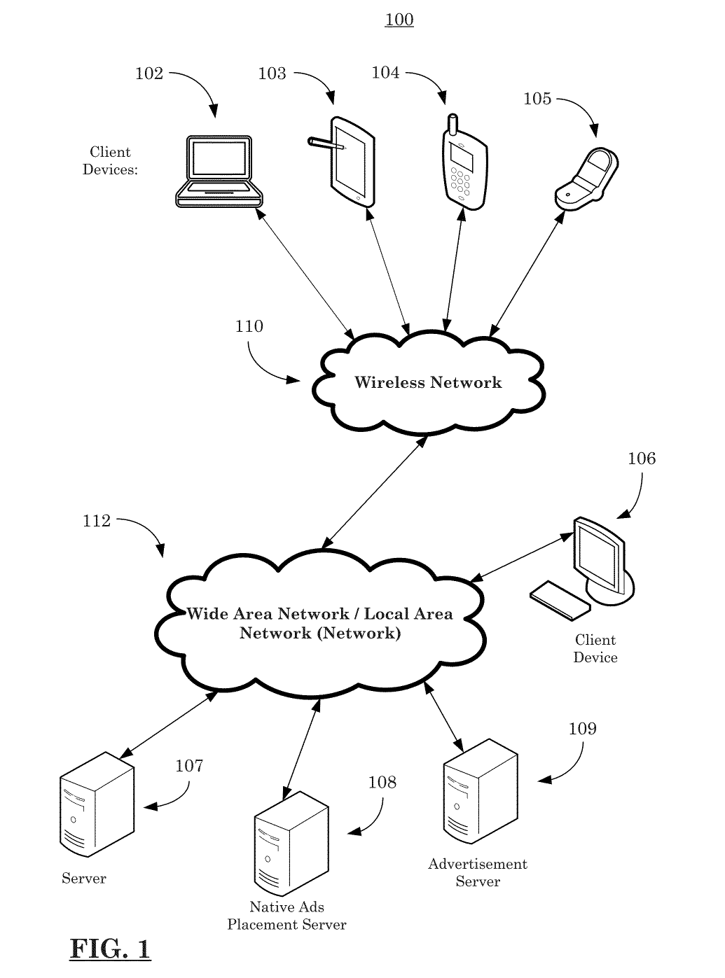

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more local area networks (“LANs”)/wide area networks (“WANs”) 112, one or more wireless networks 110, one or more wired or wireless client devices 106, mobile or other wireless client devices 102-106, one or more servers 107, one or more native ads placement servers 108 (or, in other embodiments, native content servers or native non-advertising content servers), such as may include one or more Native Advertisement Selection and Formatting engines, and one or more advertisement servers 109 (or, in other embodiments, content or non-advertising content servers), and may include or communicate with one or more data stores or databases. Several of the client devices 102-106 may include, for example, desktop computers, laptop computers, set top boxes, tablets, cell phones, smart phones, etc. The servers 107-109 can include, for example, one or more application servers, content servers, search servers, etc.

An advertisement server can include, for example, a computer server that has a role in connection with online advertising, such as, for example, in obtaining, storing, determining, configuring, selecting, ranking, retrieving, targeting, matching, serving and presenting online advertisements to users, such as on websites, in applications, and other places where users will see them, etc.

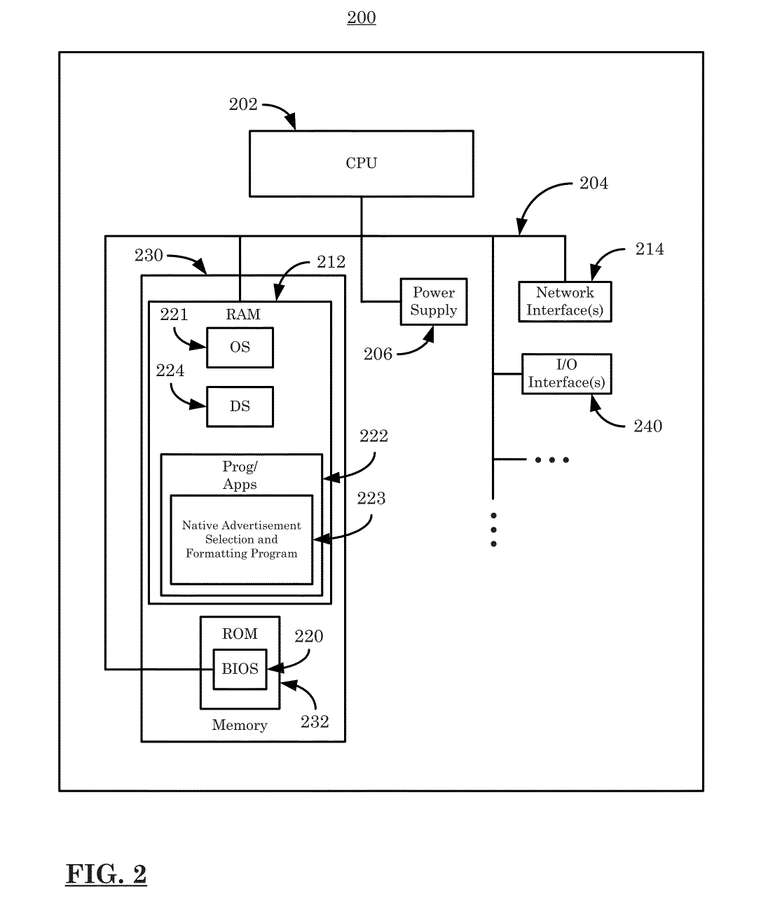

FIG. 2 illustrates a block diagram of an electronic device 200 that can implement one or more aspects of a Native Advertisement Selection and Formatting system or method according to one embodiment of the invention. Instances of the electronic device 200 may include servers, e.g. servers 107-109, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software.

The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The RAM can include an operating system 221, data storage 224, which may include one or more databases, and programs and/or applications 222, which can include, for example, software aspects of the Native Advertisement Selection and Formatting program 223. The ROM 232 can also include BIOS 220 of the electronic device.

The Program 223 is intended to broadly include or represent all programming, applications, algorithms, software and other tools necessary to implement or facilitate methods and systems according to embodiments of the invention. The elements of the Program 223 may exist on a single server computer or be distributed among multiple computers or devices or entities, which can include advertisers, publishers, data providers, etc. In some embodiments, the program may be or include a Native Advertisement Selection and Formatting engine. In other embodiments, the engine 223 can be a native content, or native non-advertising content, placement program.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network care, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Native Advertisement Selection and Formatting program 223, via a network to another device. Also, an application server may, for example, host a Web site that can provide a user interface for administration of example aspects of the Native Advertisement Selection and Formatting program 223.

Any computing device capable of sending, receiving, and processing data over a wired and/or a wireless network may act as a server, such as in facilitating aspects of implementations of the Native Advertisement Selection and Formatting program 223. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, UNIX, Linux, FreeBSD, etc.

A server may include, for example, a device that is configured, or includes a configuration, to provide data or content via one or more networks to another device, such as in facilitating aspects of an example Native Advertisement Selection and Formatting program 223. One or more servers may, for example, be used in hosting a Web site, such as the Yahoo! Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example Native Advertisement Selection and Formatting program 223. Content may include, for example, text, images, audio, video, advertisements, sponsored content, etc.

In example aspects of the Native Advertisement Selection and Formatting program 223, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in example Native Advertisement Selection and Formatting programs, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in example Native Advertisement Selection and Formatting programs, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing webpages, using a web search engine, sending and receiving messages via email, SMS, or MMS, playing games (such as fantasy sports leagues), receiving advertising, watching locally stored or streamed video, or participating in social networks.

In example aspects of the Native Advertisement Selection and Formatting program 223, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example Native Advertisement Selection and Formatting program 223, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, AppleTalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

A “content delivery network” or “content distribution network” (CDN), as may be used in an example Native Advertisement Selection and Formatting program 223, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising or advertisement selection. A “Social network” refers generally to a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network includes the person's set of direct relationships and/or indirect personal relationships. Direct personal relationships refers to relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by a “social graph” that represents each entity as a node and each relationship as an edge.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google+), or others.

In some example Native Advertisement Selection and Formatting program 223, various monetization techniques or models may be used in connection with contextual or non-search related advertising, as well as in sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bided buying and selling of online advertisement inventory from multiple ad networks. “Ad networks” refers to companies that aggregate ad space supply from publishers and provide en masse to advertisers.

For Web portals, such as Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

Some embodiments of the invention relate, directly or indirectly to native advertisement selection, formatting and placement. Advertisements can include, for example, sponsored content, promotional content, banner advertisements, online advertisements, and the like. Native advertisements can include, among other things, advertisements, such as online advertisements, that, to some degree, blend, match, flow with, or are in some ways similar to the context of the user's experience, such as may include non-advertising items or content. Native advertisements may include, among other things, sponsored content or advertisements, used interchangeably herein, such as online advertisements or online sponsored content that appears alongside, or streamlined with content such as editorial content or sponsored content, and may be displayed to mimic the surrounding content. In some embodiments, Native ads can include, among other things, formats that may match or be similar to the form or function of the user experience in which the ad is presented. In some embodiments, native advertisements may seem less obtrusive or intrusive to the user or to the user's experience.

Some embodiments of the invention relate to native advertisement selection based on keyword related information. A keyword may include words, groups of words, terms, phrases, symbols, characters and the like. In some embodiments, selection may include placement, such as what position in association with the content items the ad is to be injected into a stream of content items.

Some embodiments of the invention relate to content related applications, including, for example, any application that includes or facilitates display of particular content.

Some embodiments of the invention provide systems, methods, platforms and techniques relating to native ads, such as in connection with placement of native ads. Some embodiments include automatically detecting, locating, determining or selecting candidate locations, locations, contexts, or situations for placing or serving native ads, such as, for example, on or positioned in, or within content of, a publisher's Web site. This may include determining, for example, locations or placements, relative locations or placements, or appropriate, good or optimized locations or placements for the native ads. Such locations or placements may, for example, be at least partly based on factors consistent with form and function of native ads, which can, in some embodiments, include, among other things, non-intrusiveness, non-intrusive look or feel, continuity or blending, or a desired degree of continuity or blending with context and content, content-relatedness, not interfering with user experience or confusing users, high probability of attention, click or other desirable user action, or others. In various embodiments, this may be done without user (such as, for example, a publisher or agent of a publisher) input or action during the process, automatically, semi-automatically, or in user-assisted fashion. Some embodiments include analysis or automatic analysis of publishers' Web sites, such as, for example, in determining the candidate locations or the locations.

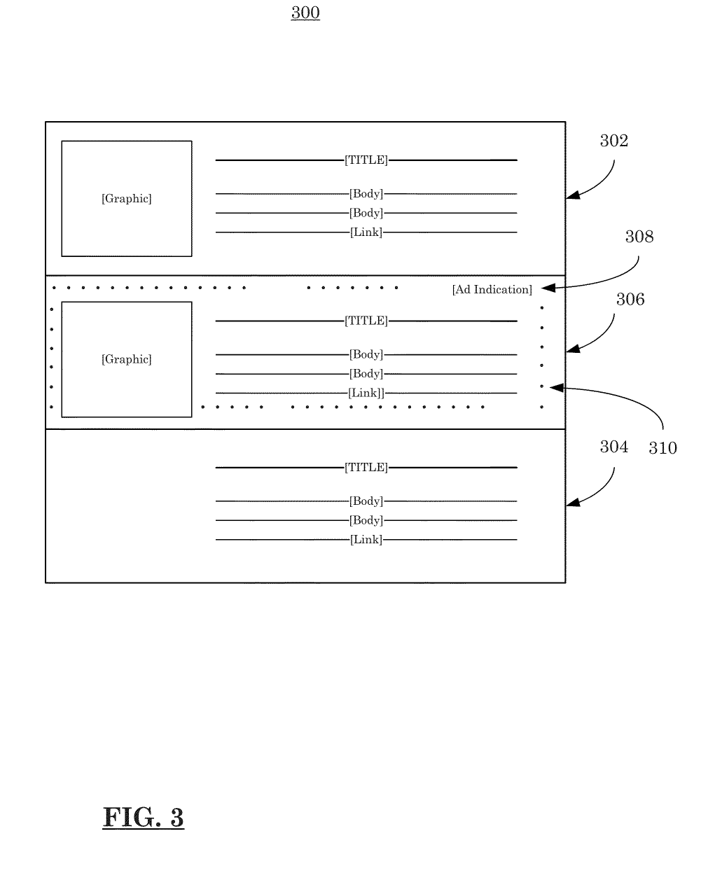

FIG. 3 illustrates a block diagram of a graphical user interface 300 according to one or more aspects of a Native Advertisement Selection and Formatting system or method according to an embodiment of the invention. In particular, FIG. 3 provides a simplified illustration of a portion of a web page including a native ad 306, selection, formatting and placement of which can be facilitated by techniques according to the invention. As depicted, the native ad 306, appears in, or injected or placed into, a group, series or flow of content items 302, 304, such as native content items. Form and function of native ads can, of course, vary, but, as depicted, the native ad 306 including a textual indication 308 that is an ad, which may also be a link, etc., as well as shading, as represented by dots 310, which may, in some embodiments, distinguish or subtly distinguish the native ad from other content items while not breaking abruptly or drastically from the content item context, for example. Each of the native ad 306 and the content items 302, 304 may include various components, which can include sub-items or sub-content, such as a link (such to an article, other content item, larger ad, etc.) title, body text, one or more graphics, and may include any number of other components, such as audio, video, etc.

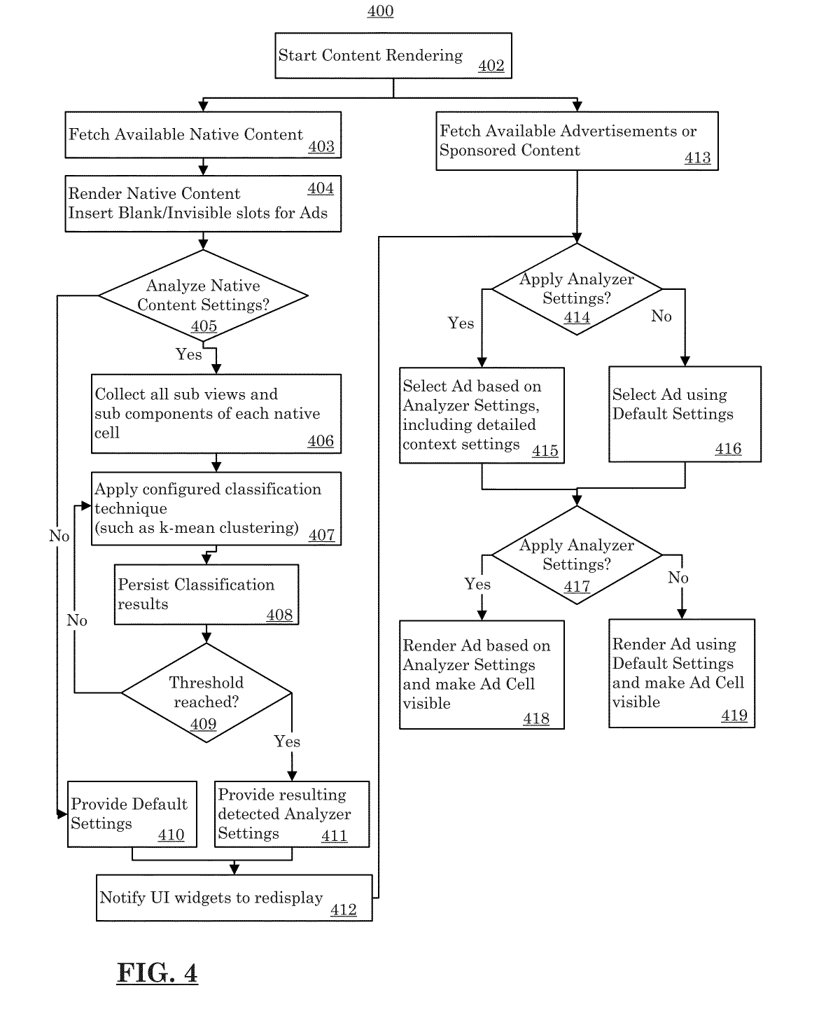

FIG. 4 illustrates a flow diagram 400 of example operations of one or more aspects of a Native Advertisement Selection and Formatting system or method according to an embodiment of the invention, performed, for example, by a Native Advertisement Selection and Formatting Engine.

At step 402, the engine prepares to start content rendering, for example, upon a user request to render content, including, for example, editorial content or sponsored content.

At step 403, the engine fetches or makes a request for available native content for rendering. Native content may include, for example, editorial content, or sponsored content, or other types of content.

At step 404, the engine begins to render native content on the requested device, for example, a mobile device or a desktop computer. The engine inserts blank or invisible slots, for example as placeholders, for advertisements or sponsored content.

At step 405, the engine determines whether to analyze native content and determine settings, for example, whether the settings analyzer is enabled on the user device or in the program or user settings, whether the device has analyzer capabilities, or the like. If not, the engine proceeds to step 410 and provides default settings, for example, to be used for ad selection and/or formatting.

At step 406, the engine proceeds to traverse and collect all sub views and sub components of each native cell within the fetched native content.

At step 407, the engine applies a configured classification technique, for example a k-mean clustering technique.

At step 408, the engine persists classification results until a threshold is reached at step 409. The threshold may be predetermined or preset and based on one or more metrics.

At step 409, the engine determines whether the threshold is reached, and if not, the engine goes back and continues to apply configured classification technique in step 407 and persist classification results in step 408. Otherwise, the engine proceeds to step 411.

At step 411, the engine provides resulting detected native content analyzer settings.

At step 410, alternatively, or in addition, the engine provides default settings, for example, after determining not to analyze native content at step 405.

At step 412, the engine notifies UI widgets to redisplay, for example, based on default or analyzer settings.

At step 413, the engine fetches or makes a request for available advertisements or sponsored content.

At step 414, the engine determines whether to apply analyzer settings when selecting appropriate ads. For example, keyword and formatting information and other analyzer settings may be used to select matching ads. If not, the engine proceeds to step 416 and selects ads using default settings. Otherwise, the engine proceeds to step 415.

At step 415, the engine selects ads based on the analyzer settings, including detailed context settings, and including for example keyword and formatting information.

At step 416, alternatively, or additionally, the engine selects ads using default settings.

At step 417, the engine determines whether to apply analyzer settings when rendering ads or sponsored content. If not, the engine proceeds to step 419 and renders the ad using default settings. Otherwise, the engine proceeds to step 418.

At step 418, the engine renders ads based on analyzer settings and makes the ad cell visible.

At step 419, alternatively, or in addition, the engine renders ads using default settings and makes ad cells visible.

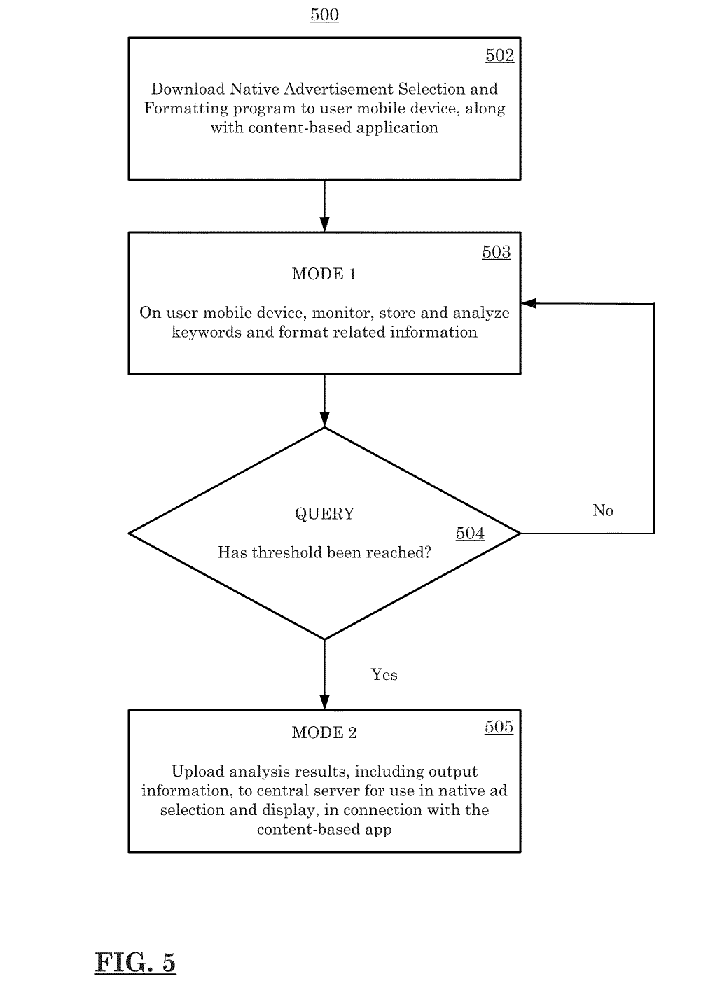

FIG. 5 illustrates a flow diagram 500 of example operations of one or more aspects of a Native Advertisement Selection and Formatting system or method according to an embodiment of the invention, performed or facilitated, for example, by a Native Advertisement Selection and Formatting Engine.

At step 502, the engine facilitates to download a Native Advertisement Selection and Formatting program to a user mobile device, along with a content-based application.

At step 503, the engine, in mode 1, on the user mobile device, monitors, stores and analyzes keywords and format related information.

At step 504, the engine determines whether a threshold has been reached. If not, the engine goes back to step 503. Otherwise, the engine proceeds to step 505.

At step 505, the engine, in mode 2, uploads analysis results, including output information, to a central server for use in native ad selection and display, in connection with the content-based app.

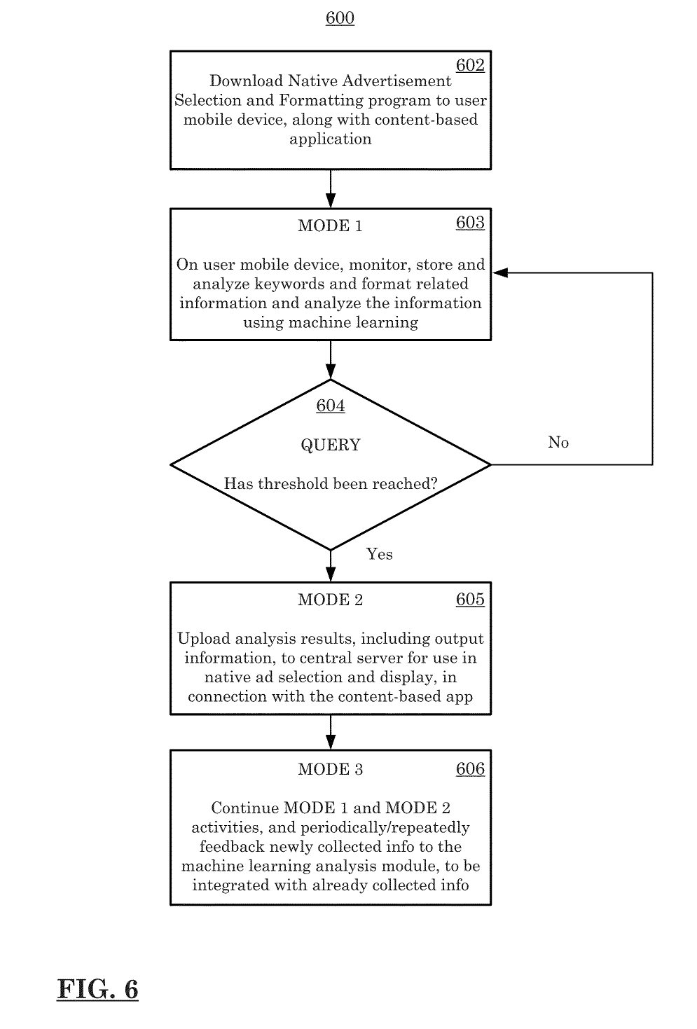

FIG. 6 illustrates a flow diagram 600 of example operations of one or more aspects of a Native Advertisement Selection and Formatting system or method according to an embodiment of the invention, performed, for example, by a Native Advertisement Selection and Formatting Engine.

At step 602, the engine downloads a Native Advertisement Selection and Formatting program to a user mobile device, along with a content-based application.

At step 603, the engine, in mode 1, on the mobile device, monitors, stores and analyzes keywords and format related information, and analyzes the information using machine learning.

At step 604, the engine determines whether a threshold has been reached. If not, the engine goes back to step 603. Otherwise, the engine proceeds to step 605.

At step 605, the engine, in mode 2, uploads analysis results, including output information, to a central server for use in native ad selection and display, in connection with the content-based app.

At step 606, the engine, in mode 3, continues mode 1 and mode 2 activities, and periodically and/or repeatedly feeds back newly collected information to a machine learning analysis module, to be integrated with already collected information.

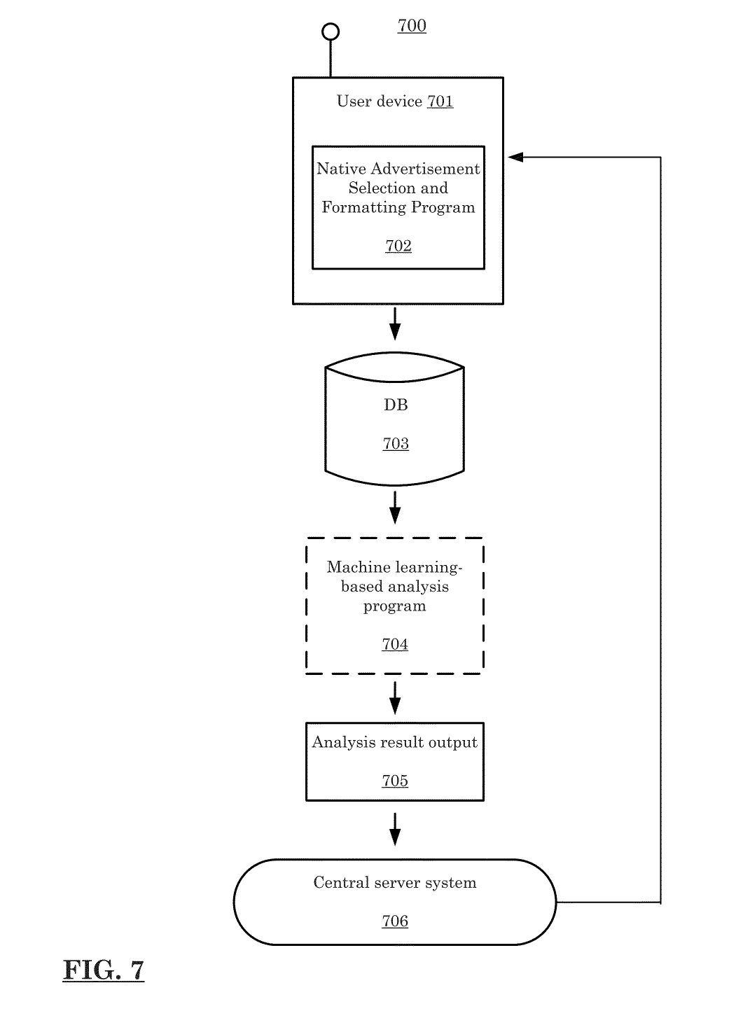

FIG. 7 illustrates a diagram 700 of example operations of one or more aspects of a Native Advertisement Selection and Formatting system or method according to an embodiment of the invention, including user device 701, Native Advertisement Selection and Formatting Program 702, Database (DB) 703, which may be an external DB or an internal DB on the user device, machine learning-based analysis program 704, analysis result output 705 and central server system 706. In some embodiments, user device 701, while running Native Advertisement Selection and Formatting Program 702, may provide information to DB 703, which may be used by machine learning-based analysis program 704 to produce analysis result output 705, sent to central server system 706 and fed back to user device 701 to be utilized by Native Advertisement Selection and Formatting Program 702.

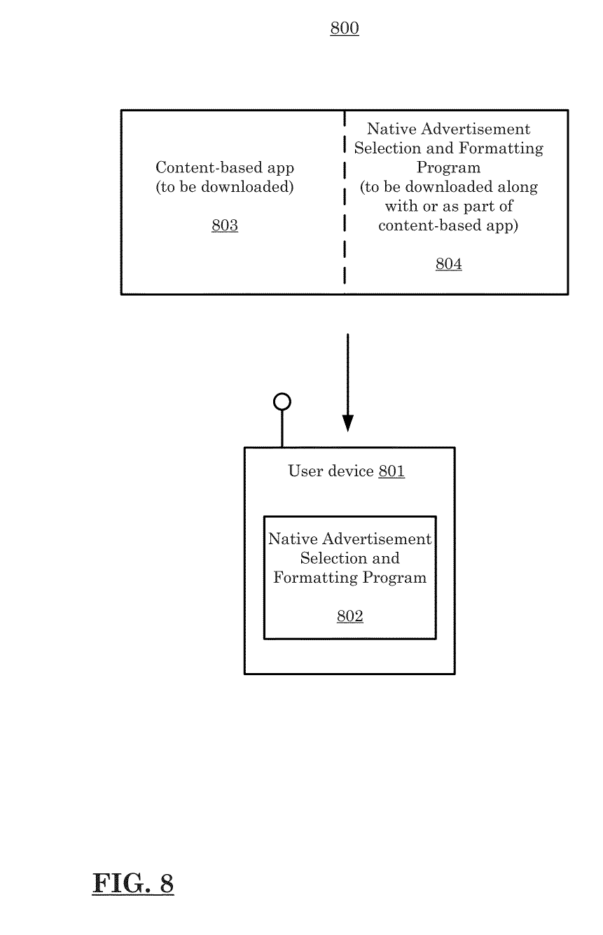

FIG. 8 illustrates a diagram 800 of example operations of one or more aspects of a Native Advertisement Selection and Formatting system or method according to an embodiment of the invention, including user device 801, Native Advertisement Selection and Formatting Program 802, content-based app 803, and Native Advertisement Selection and Formatting Program 804. In some embodiments, content-based app 803 and Native Advertisement Selection and Formatting Program 804 are downloaded on user device 801, in order to install and execute Native Advertisement Selection and Formatting Program 802 on user device 801. In some embodiments, content-based app 803 and Native Advertisement Selection and Formatting Program 804 are transferred to user device 801. In some embodiments, Native Advertisement Selection and Formatting Program 804 may be downloaded or acquired, along with, or as part of, content-based app 803.

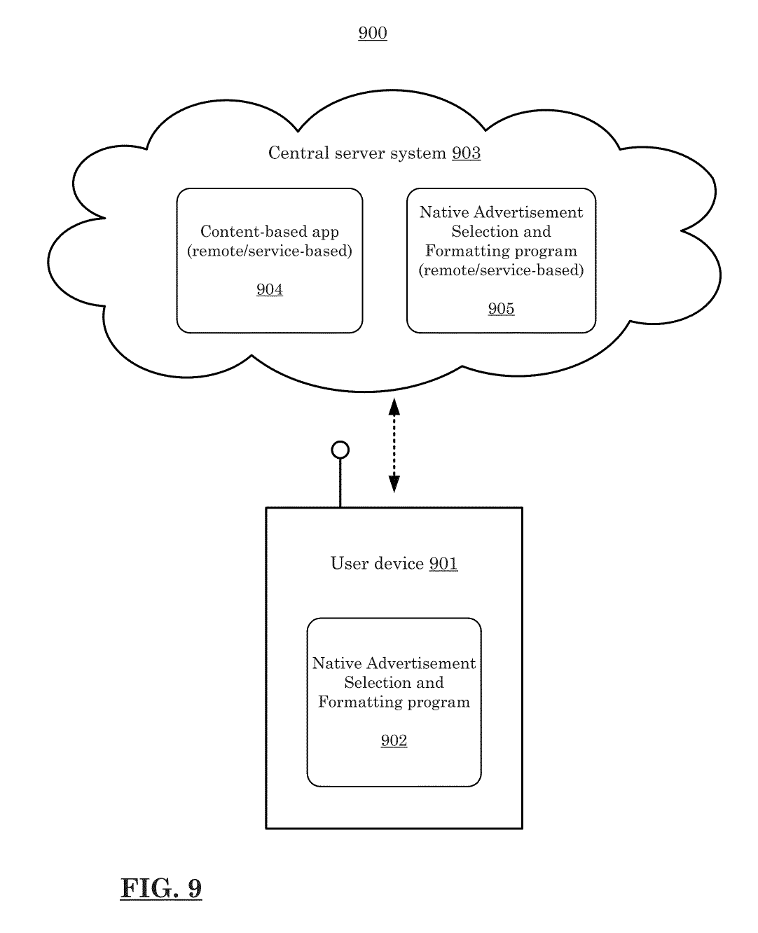

FIG. 9 illustrates a diagram 900 of example operations of one or more aspects of a Native Advertisement Selection and Formatting system or method according to an embodiment of the invention, including user device 901 including, Native Advertisement Selection and Formatting Program 902, central server system 903 including service based, or remote, content-based app 904 and Native Advertisement Selection and Formatting Program 905. In some embodiments, 904 and Native Advertisement Selection and Formatting Program 905 are provided remotely or as services to user device 901 running Native Advertisement Selection and Formatting Program 902, used to collect information in the device.

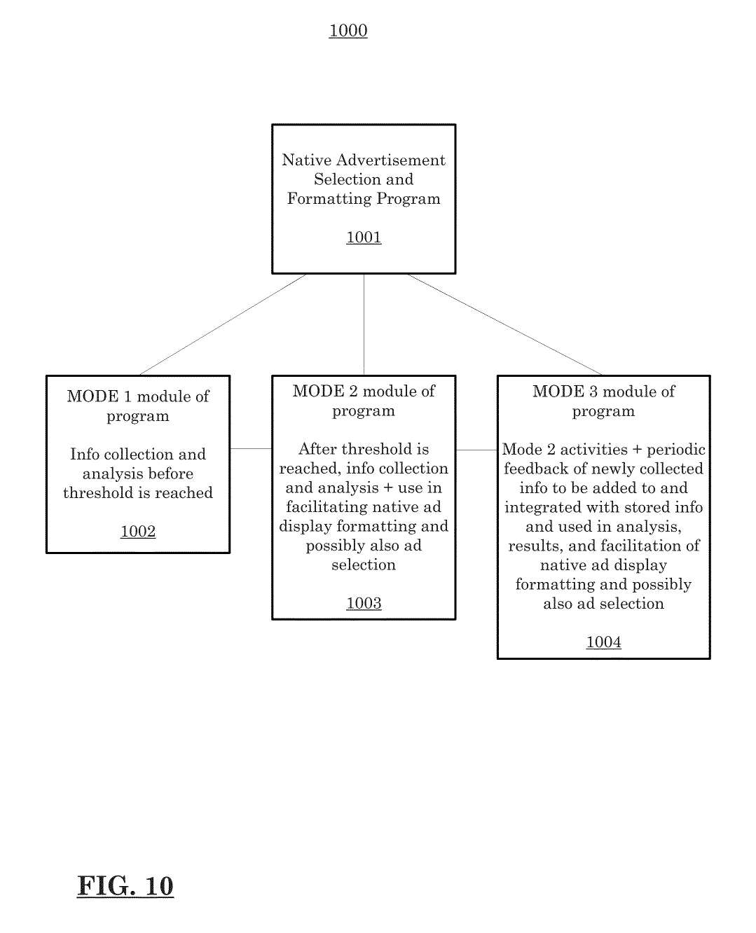

FIG. 10 illustrates a diagram 1000 of example operations of one or more aspects of a Native Advertisement Selection and Formatting system or method according to an embodiment of the invention, including Native Advertisement Selection and Formatting Program 1001 which includes Mode 1 module 1002, Mode 2 module 1003 and Mode 3 module 1004. Mode 1 module 1002 of program 1001 is configured for information collection and analysis before a threshold is reached. Mode 2 module 1003 of program 1001 is configured for, after reaching the threshold, information collection and analysis and use in facilitating native ad display formatting and possibly also ad selection. Mode 3 module 1004 of program 1001 is configured for continuing Mode 2 activities and providing periodic feedback of newly collected information to be added to and integrated with stored info and used in analysis, results, and facilitation of native ad display formatting and possibly also ad selection.

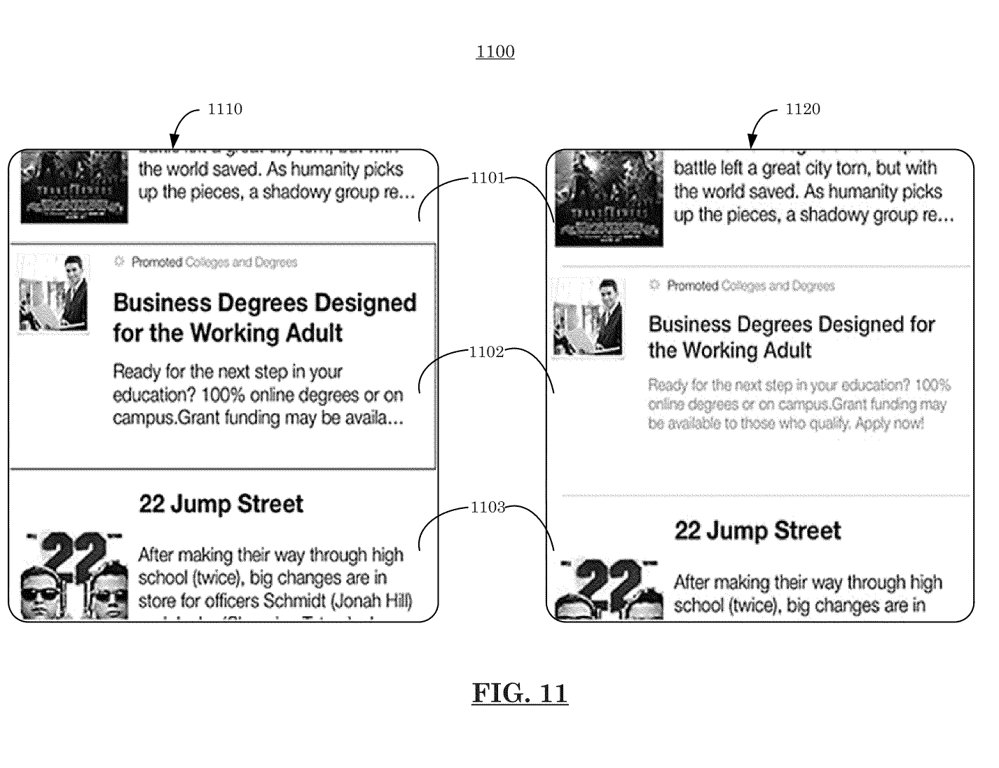

FIG. 11 illustrates a diagram 1100 of example graphical user interfaces of one or more aspects of a Native Advertisement Selection and Formatting system or method according to an embodiment of the invention, including analyzed interface 1110 and non-analyzed interface 1120. Specifically, FIG. 11 provides a comparison of a user interface with the settings analyzer on (analyzed interface 1110) and a user interface with the settings analyzer off (non-analyzed interface 1120) of a portion of a web page including a native ad 1102, selection, formatting and placement of which can be facilitated by techniques according to one or more aspects of a Native Advertisement Selection and Formatting system or method. As depicted, the native ad 1102, appears in, or injected or placed into, a group, series or flow of content items 1101 and 1103, such as native content items.

According to aspects of a Native Advertisement Selection and Formatting system or method according to an embodiment of the invention, the system or method may provide a program, which may, for example, be downloaded with a content-related application, or “app”, to a user device, such as a smart phone. The program may, for example, be designed to facilitate or optimize selection and display of native ads. In some embodiments, the program, after being downloaded, executes on the user device. The program may initially collect and store information relating to the app, which may include keyword-related information as well as format-related information. The program may use one or more machine learning techniques to analyze the collected information. In some embodiments, once a pre-defined threshold has been reached, such as a point where sufficient information has been collected or sufficient confidence has been determined to be reached in the results of the analysis, the program begins facilitating utilization of the results of the analysis in selection and display of native ads. In some embodiments, advantages are realized without need for publisher action, such as tagging, etc.

For example, in some embodiments, the results of the analysis may include frequently occurring keywords and frequently used formatting, and may include statistical information relating thereto, such as specific frequency information and confidence information. Once sufficient confidence has been determined to be reached (or sufficient data collected and analyzed, or other threshold indicator(s) reached), the program may make the analysis results available to facilitate or optimize native ad selection and display.

For example, the result information may be uploaded to a central server system, which system may use the result information (along with other information and criteria) to optimally select a native advertisement for display in connection with content displayed by the app, such as an ad in a stream of content items, for example.

Some embodiments of the invention include a program (which can, for example, include an application, etc.) that may be downloaded to a user mobile device, or other device, such as from a remote system or central server system. In some embodiments, the program may be downloaded (or otherwise acquired or placed) along with (with or without user knowledge) or even as part of, another downloaded program, such as an application or “app” (even though other embodiments are contemplated in which programs and applications are remotely provided, such as a “service”-based software-providing system). For example, the user may download a content-related app, such as a news app, for example, such as from an app “store”, from the user's smart phone. The program may be downloaded with (such as at the same time or nearly the same time) or as part of the news app (such as by being actually part of, and integrated with the news app, or being a modular add-on to the news app or programming, or otherwise being associates with the news app, for example). In some embodiments, the program may be customized to the news app, or, in other embodiments, the program may be designed to work for any of a number of apps or types of apps (or programs, etc.).

In some embodiments, the downloaded program may execute and operate to collect information, including keyword-related and format-related information, relating to the app. For example, when the app is running, the program may collect information relating to keywords occurring in displayed content items, as well as formatting of displayed content items (or ads). In some embodiments, the information may be affected by many factors which can include settings (such as automatic, user-configurable or user-influenced settings, etc.) of the device or device display, settings of the app, etc.

In some embodiments, the program may utilize one or more machine learning techniques, such as via the program executing on the user device, in analyzing, or storing and analyzing, the collected information to produce results information. In some embodiments, the machine learning techniques may be modified or simplified to run practically on a user device. On other embodiments, the machine learning techniques may be implemented remotely or partly remotely, which could include uploading and downloading of information from a central server system.

In some embodiments, the program is configured to detect, or check or check repeatedly for and detect, when a pre-defined threshold is reached or passed. Once the threshold is reached or passed, the program may switch to a different mode in which ad selection and formatting is or may be facilitated (and information may continue to be collected and analyzed, and analysis results produced and utilized, as well). For example, in some embodiments, once the threshold is reached, results information may be uploaded to a central server system and utilized to facilitate ad selection and display or display planning. For example, the threshold may relate to a minimum measure of an amount of collected and analyzed data, a minimum measure of amount of confidence in result information, a minimum measure of cluster cohesiveness in applied machine learning techniques or algorithms, etc. Furthermore, in some embodiments, the results information may be utilized by the device and/or app in locally facilitating ad selection or formatting.

According to aspects of a Native Advertisement Selection and Formatting system or method according to an embodiment of the invention, the system or method may operate in several modes, including a machine learning mode, content placement mode, and an incremental learning mode. In the machine learning mode, the system or method inspects existing content or native content at runtime, based on visual and textual aspects of the content, and classifies each type of attribute related to the existing content. In the content placement mode, the system or method selects advertisement or sponsored content relevant to aspects of the existing native content and provides a detailed rendering context for the advertisement or sponsored content, for rendering the native ads. In the incremental learning mode, the system or method continues to operate and classify existing native content until confidence in classification reaches a signal-to-noise ratio threshold. In some embodiments, switching from machine learning mode to content placement mode depends on the clustering algorithm chosen. For example, the stopping criteria may include a set threshold such as the number of iterations, the number of existing content data items, or a measure of clustering quality, or a combination thereof.

In some embodiments, the program may switch from mode 1, an information collection and analysis mode to mode 2, an ad selection and display facilitation mode. In some embodiments, once in mode 2, the program may modify, limit, discontinue, or temporarily discontinue, the activities of mode 1. However, in some embodiments, mode 2 can include continuing the activities of mode 1.

In some embodiments, the program may further operate in mode 3, which may be an incremental learning and feedback mode, utilizing one or more machine learning techniques. For example, in some embodiments, the incremental learning mode can be a mode in which the program, once actually facilitating ad selection and display, continues to collect, analyze and produce result information, which may be added to and used cumulatively with already collected information, such as information collected before switching to mode 2. In some embodiments, mode 3 can include a feedback function in which feedback information such as performance information, such as performance of native ads, etc., may be integrated into the collected and analyzed information, to allow for improved, honed, optimized or more precise or confidence-associated result information, for example.

Some embodiments use one or more machine learning techniques, which can include one or more machine learning models, such as matrix-based and feature-based models, in analyzing collected information (which can include collecting, organizing, integrating, modeling, analyzing, etc. For example, in some embodiments, the program includes a classifier module, such as for identifying features, attributes or characteristics of data or items, such as keyword-related or content-related features. Furthermore, in some embodiments, clustering, such as histogram-based clustering, may be used in organizing and analyzing data. One or more mode-related thresholds can be associated with aspects of clustering or clustering characteristics or results.

According to aspects of a Native Advertisement Selection and Formatting system or method according to an embodiment of the invention, the system or method may start by inspecting existing native content, including text, at runtime, that is, when content is being rendered online and/or on a mobile device. Existing native content may include a blog post, a newspaper article, sponsored content, or any other content, including graphical widgets, images, text, video, or any other content displayable online or on a mobile device. The system or method may traverse the existing content piece by piece, for traversing depth first or breadth first through all of the existing native content cells and walk through all the displayed widgets. The system or method may access all of the graphical user interface elements being displayed, including, for example, text labels, image views, video and the like. The system or method may accomplish navigating existing native content by utilizing existing platform APIs of the mobile device or web user interface, or the like.

According to aspects of a Native Advertisement Selection and Formatting system or method according to an embodiment of the invention, upon analyzing the native content, the system or method may classify each type of element within the existing native content and analyze the text within the existing content for context, including topical or keyword information. The system or method may classify and group a predetermined set of attributes, including, for example, font attributes such as font size, family, color, and emphasis information. For example, the system or method may determine which font is most commonly used for headings. The system or method may also classify or group text label sizes, background colors of cells hosting the content, background colors of cells hosting the content, image sizes, number of images per container, orientation of the image, padding attributes, margin information, distance between image and text, and the like. In some embodiments, the system or method may analyze a predetermined minimum number of data items before providing results of the classification or grouping. The system or method may group various attributes to determine, for example, most common elements, such as a most commonly used font in headings. Other examples of most common elements include, for example, most frequently used background color, small font, large font, cell size, and the like, and average, median, or standard deviation of padding sizes and cell sizes, and the like. This information may be used to select ads or sponsored content to contextually or visually match the existing content and render as native ads. The system or method may exclude outlier content or data items from classification, for example, by detecting the signal-to-noise ratio of the elements being classified to exclude aberrations.

According to aspects of a Native Advertisement Selection and Formatting system or method according to an embodiment of the invention, upon analyzing the existing native content, the system or method may classify and analyze the existing content by utilizing a predetermined classification algorithm such as a K-means clustering algorithm or a histogram based classification, or the like. The system or method may create k-centroids for each attribute and classify each attribute.

According to aspects of a Native Advertisement Selection and Formatting system or method according to an embodiment of the invention, upon analyzing the existing native content, the system or method may analyze the text within the existing content for context, including topical or keyword information. The system or method may traverse and inspect all the text being displayed within the existing native content. The system or method may build a keyword histogram along with emphasis attributes. This information may be used to select ads or sponsored content to contextually match the existing native content and display native ads within the existing native content.

According to aspects of a Native Advertisement Selection and Formatting system or method according to an embodiment of the invention, the system or method may place advertisement or sponsored content streamlined and blended with existing native content. The system or method requests an ad from a backend server system according to particular settings, for example, detected when analyzing the existing content. The system or method provides to the backend server system detected settings, including, for example, a keyword histogram and an emphasized keywords histogram, along with other detected settings. The system or method may determine and select appropriate ads or sponsored content, based on the provided settings and keywords that are relevant to the existing native content. The ads or sponsored content may be provided in JSON or similar standard format through a web service, including at least one of heading, images, description, click URL, impression beacon URL, specific rendering template instruction, advertisement or sponsored content indicating icons, and the like. The system or method receives the selected advertisement or sponsored content and related data and parses the received data. Based on this information, the system or method may determine detailed rendering context, to provide to the ad cell where the ad is targeted to appear within the existing content. The ad cell, based in part on the detailed rendering context information renders the ad within the ad cell, within the existing native content.

According to aspects of a Native Advertisement Selection and Formatting system or method according to an embodiment of the invention, the system or method may continuously classify existing native content while measuring confidence of the classification. The confidence may be measured, for example, by metrics including a signal-to-noise ratio. The system or method may provide classification results, for rendering the native ads, when the confidence in classification is above a predetermined threshold, for example, related to the confidence metrics.

According to aspects of a Native Advertisement Selection and Formatting system or method according to an embodiment of the invention, the system or method may utilize cluster cohesiveness in relation to switching to content placement mode.

The switch from mode 1, machine learning mode, to mode 2, Ad/Sponsored content placement mode, may depend on the clustering algorithm chosen. In general the stopping criteria is either a set threshold such as number of iterations, number of native data items, or a measure of clustering quality, or in some instances a combination of both. Cluster cohesiveness is a measure of cluster quality, i.e., how closely are data distributed around a centroid. There are many measures and coefficients that may be used for cluster cohesiveness, for example Sum of Squared Errors (SSE), Mean Squared Error (MSE), and Total Sum of Squared Errors (TSSE) across all clusters.

The SSE for a cluster may be represented as follows:

Σdistance(k,p)2

pεC

Where p is a point in the cluster, k is the cluster's centroid and C is the set of points that make up the cluster.

The MSE for a cluster may be represented as follows:

SSE/n

Where n is the set of points in a given cluster for which the MSE is being computed.

The TSSE across all clusters may be represented as follows:

ΣSSEc

cεEC

Where c is a cluster in EC, which is the entire set of all clusters, SSEc is the SSE for the cluster c.

The better the quality of clustering, the lower the above 3 metrics will be. Additionally, more complex quality metrics may be used, such as Silhouette Coefficient, which also measures cluster separation.

For a simple histogram based algorithm, the stopping criteria for mode 1, learning mode, is the number of native data items analyzed. For example, once the analyzer has read 20 native articles that contain sufficient data, the algorithm has enough data to make a prediction. The algorithm may look for the statistical distribution of fonts and colors and pick the most frequently used large fonts and small fonts, colors etc.

For example, a count based histogram of fonts may include a set of tuples: (font, count_{—} occurrences (font)), where count_{—} occurrences is a function that returns the count of occurrences of that font in the analyzed cells. From this relation, top ‘n’ most frequently occurring fonts can be mined. The mined occurrences may then be classified further by another dimension such as their font size, to ultimately determine the most frequently used large font, and the like.

The standard clustering algorithms such as k-means clustering and hierarchical clustering may require a measure of distance. The definition of distance in the context of native settings analysis may include the magnitude of the display attribute being clustered. For example, a distance between a font of size 16 and a font of size 12 may be defined as the difference of the font size magnitudes, in this case 4. As another example, a background color may correspond to a normalized RGB (red green blue) value of 0.55 and another background color may correspond to 0.60. The distance between these two colors can be computed as the difference between the magnitudes, in this case 0.05. For example, distance_font_size (fontX, fontY)=|sizeof (fontX)−sizeof (fontY)| where size of function returns the displayed size of the font as a number and fontX and fontY are the fonts being analyzed for distance.

In some embodiments, more complicated distance computations may be plugged in. For example, computation of the distance between font families (e.g. Cambria, Helvetica) requires assigning a numeric magnitude attribute to a font family by a font expert, in order to be ranked or analyzed by similarity.

For k-means clustering algorithms, the stopping criteria may include a combination of a number of iterations for which the algorithm is run and a measure of cluster cohesiveness. For example, the number of iterations on k-means clustering algorithm may be set to 100 and setup the TSSE to 0.75, so in this case if the cluster TSSE reaches at or below 0.75 before 100 iterations the algorithm stops, else it continues until 100 iterations and then stops.

For hierarchical clustering algorithms, the stopping criteria may include the cluster cohesiveness measure such as TSSE or Silhouette Coefficient and potentially computational time. If the cluster computation does not yield a desired amount of cluster cohesiveness, for example, as measured by TSSE, within a specified time, the algorithm may stop learning.

While the invention is described with reference to the above drawings, the drawings are intended to be illustrative, and the invention contemplates other embodiments within the spirit of the invention.

1. A system comprising one or more processors and a non-transitory storage medium comprising program logic for execution by the one or more processors, the program logic comprising:
a native advertisement selection and formatting module operable to:
monitor displayable content and store characteristic-related information relating to the monitored content, including keyword-related information and format-related information;
utilizing one or more machine learning-based algorithms, analyze the characteristic-related information relating to the monitored content, including the keyword-related information and the format-related information;
based in part on the analysis, output detailed contextual settings; and
select and format native advertisements to be displayed in visual association with the displayable content, based in part on the detailed contextual settings.

2. The system of claim 1, wherein selecting and formatting native advertisements further comprises selecting native advertisements based on detailed contextual settings related to keyword-related information.

3. The system of claim 1, wherein selecting and formatting native advertisements further comprises formatting native advertisements based on detailed contextual settings related to format-related information.

4. The system of claim 1, wherein detailed contextual settings include keyword-related information relating to determined frequently occurring keywords of the displayable content.

5. The system of claim 1, wherein detailed contextual settings include format-related information relating to determined frequently occurring content formatting characteristics of the displayable content.

6. The system of claim 1, wherein the displayable content includes mobile content being rendered on a content-related application.

7. The system of claim 1, wherein the native advertisement selection and formatting module is downloaded to a computerized mobile user device along with a content-related application.

8. The system of claim 1, wherein the native advertisement selection and formatting module is a remote service-based module.

9. The system of claim 1, further comprising analyzing the characteristic-related information until a threshold is reached, wherein the threshold includes at least one of a number of interactions, number of native data items analyzed, and a measure of clustering quality.

10. A method comprising:
monitoring displayable content and storing characteristic-related information relating to the monitored content, including keyword-related information and format-related information;
utilizing one or more machine learning-based algorithms, analyzing the characteristic-related information relating to the monitored content, including the keyword-related information and the format-related information;
outputting detailed contextual settings based in part on the analysis; and
selecting and formatting native advertisements to be displayed in visual association with the displayable content, based in part on the detailed contextual settings.

11. The method of claim 10, wherein selecting and formatting native advertisements further comprises selecting native advertisements based on detailed contextual settings related to keyword-related information.

12. The method of claim 10, wherein selecting and formatting native advertisements further comprises formatting native advertisements based on detailed contextual settings related to format-related information.

13. The method of claim 10, wherein detailed contextual settings include keyword-related information relating to determined frequently occurring keywords of the displayable content.

14. The method of claim 10, wherein detailed contextual settings include format-related information relating to determined frequently occurring content formatting characteristics of the displayable content.

15. The method of claim 10, wherein the displayable content includes mobile content being rendered on a content-related application.

16. The method of claim 10, wherein the native advertisement selection and formatting module is downloaded to a computerized mobile user device along with a content-related application.

17. The method of claim 10, wherein the native advertisement selection and formatting module is a remote service-based module.

18. The method of claim 10, further comprising analyzing the characteristic-related information until a threshold is reached,

19. The method of claim 18, wherein the threshold includes at least one of a number of interactions, number of native data items analyzed, and a measure of clustering quality.

20. A non-transitory computer-readable storage medium or media tangibly storing computer program logic capable of being executed by a computer processor, the program logic comprising:
a native advertisement selection and formatting engine logic operable to:
monitor displayable content and store characteristic-related information relating to the monitored content, including keyword-related information and format-related information;
utilizing one or more machine learning-based algorithms, analyze the characteristic-related information relating to the monitored content, including the keyword-related information and the format-related information, and based in part on the analysis, output detailed contextual settings; and
select and format native advertisements to be displayed in visual association with the displayable content, based in part on the detailed contextual settings.
